(19) United States
(12) Patent Application Publication
(10) Pub. No.: US 2006/0056630 A1
(43) Pub. Date: Mar. 16, 2006

(54) Method to support secure network booting using quantum cryptography and quantum key distribution

(76) Inventors: Vincent J. Zimmer, Federal Way, WA (US); Michael A. Rothman, Puyallup, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/940,196

(22) Filed: Sep. 13, 2004

(51) Int. Cl. H04K 1/00

(52) U.S. Cl. 380/256

(57) ABSTRACT

A method and system to support secure booting and configuration. The mechanism employs an optical link comprising a quantum channel that is used to send data encoded as quantum bits (qubits) via respective photons. Qubits encoded using a first random basis at the client and are sent to the boot server, which processes the qubits using a second random basis to extract the encoded data. A public channel is used to send data indicative of the second random basis to the client. A symmetric quantum key is then derived a both the client and the boot server using a comparison of the random basis' and the original and extracted data. The scheme enables the presence of an eavesdropper to be detected on the quantum channel. A DHCP message exchange is employed to obtain a network address, and, optionally, be provided with a network address for one or more boot servers. A boot image request is made to the boot server by the client, and a subsequent boot image is downloaded via a secure channel facilitated by the symmetric quantum key.

### FIELD OF THE INVENTION

The field of invention relates generally to computer systems and, more specifically but not exclusively relates to techniques that enable secure network booting using quantum cryptography and quantum key distribution (QKD) techniques.

### BACKGROUND INFORMATION

It is becoming ever more common to provide network booting of operating systems (OS) in enterprise environments, web server environments, and the like. Under a network operating system boot, an OS image is loaded (booted) from a network resource, such as a boot server. This scheme provides advantages relating to configuration control and generally reduces IT management costs, while at the same time reducing licensing costs.

While advantageous in many ways, the conventional network-booting scheme is unsecure. For instance, an insider may advertise the availability of a rogue boot server masquerading as a legitimate boot server that serves malicious OS images. The net result is that unknowing users load a malicious OS image, which may contain a virus that causes widespread havoc or a Trojan that sits unnoticed for days, weeks, or months until an activation event occurs, causing the Trojan code to be launched.

In view of this problem, techniques have been developed to authenticate boot images (or boot servers hosting such boot images) such that malicious or otherwise unauthentic images can be easily identified, preventing such images from being booted. For example, BOOT Integrity Services, commonly called BIS, provide a mechanism to authenticate a boot image that is derived from a DHCP (Dynamic Host Configuration Protocol) offer. Even through the mechanism is sufficient to ascertain that the image is not modified in any way (i.e., is authentic), it has some shortcomings that may prevent its use in more secure environments.

One problem is the conventional scheme uses digital certificates that need to be certified. The certificate generated by the server needs to be authenticated by CA (Certificate Authority) and CRL (Certificate Revocation List) if not Self-Signed. If one of these servers is down, a false certificate may accidentally be accepted. In the case of Self-Signed certificated, its origin cannot be verified. Even though there is a provision for public key cryptography, an established mechanism for authentication of the client and boot server is still lacking. This may cause a malicious DHCP Server to act as a “Man in the Middle” or a “Malicious Proxy DHCP Server.”

Another problem with conventional public key cryptography techniques is that they are susceptible attack. For example, keys may be “stolen” by monitoring network traffic sent over conventional network infrastructure, such as Ethernet links; equipment for performing this type of monitoring is readily available and widely known. Furthermore, detection of the existence of this type of monitoring is generally impossible or impracticable.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified, and wherein:

FIG. 1a is a schematic diagram illustrating an exemplary encryption scheme to define binary values using rectilinear and diagonal photon polarization;

FIG. 1b is a schematic diagram illustrating how photons having a vertical or horizontal polarization pass through a rectilinear basis filter unperturbed;

FIG. 1c is a schematic diagram illustrating how photons having a diagonal (+45° and −45°) polarization pass through a diagonal basis filter unperturbed;

FIG. 1d is a schematic diagram illustrating how when a photon having a diagonal (+45° and −45°) polarization passes through a rectilinear filter the polarization of the photon is randomly changed to a random rectilinear polarization;

FIG. 1e is a schematic diagram illustrating how when a photon having a vertical or horizontal polarization pass through a diagonal filter the polarization of the photon is randomly changed to a random diagonal polarization;

FIG. 2 is a flowchart illustrating operations performed to generate a symmetric quantum key using the BB84 quantum key distribution protocol;

FIG. 3 is a schematic diagram illustrating an exemplary symmetric quantum key generation process in accordance with the flowchart of FIG. 2;

FIG. 4 is a schematic diagram of an exemplary network architecture including a fiber-based quantum channel that is used to generate and distribute the symmetric quantum key;

FIG. 4a is a schematic diagram of an exemplary network architecture including a quantum channel that is facilitated by an free-space optical link;

FIG. 5 is a flowchart illustrating operations performed during a secure boot operations that is implemented via a secure channel facilitated by the use of one or more symmetric quantum keys, according to one embodiment of the invention;

FIG. 6 is a message flow diagram illustrating messages passed between a pre-execution environment (PXE) client, a dynamic host control protocol (DHCP) server or DHCP proxy and between the PXE client and a boot server during the secure boot process of FIG. 5; and

FIG. 7 is a schematic diagram of an exemplary computer system that may be used to perform various operations corresponding to the embodiments described herein.

### DETAILED DESCRIPTION

Embodiments of methods and systems to support secure network booting using Quantum Cryptography (QC) and Quantum Key Distribution (QKD) techniques are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Embodiments of the present invention provide a secure network boot flow that implement security schemes that are facilitated, in part, via use of quantum key distribution mechanisms. Rather than employing conventional key distribution techniques, session security data are transmitted between a client and a boot server during pre-boot using a secure channel implemented via symmetric keys obtained via QKD techniques. In order to better understand and appreciate the techniques, a discussion of QC security elements is now provided.

Quantum Cryptography is based on Quantum Physics, which have been studied since the early 20^{th} century. Quantum Physics establishes a set of well-known negative rules stating things that cannot be done. For example:
1. Every measurement perturbs the system.
2. One cannot determine simultaneously the position and the momentum of a particle with arbitrary high accuracy.
3. One cannot measure the polarization of a photon in the vertical-horizontal basis and simultaneously in the diagonal basis (Heisenberg uncertainty).
4. One cannot duplicate an unknown quantum state.

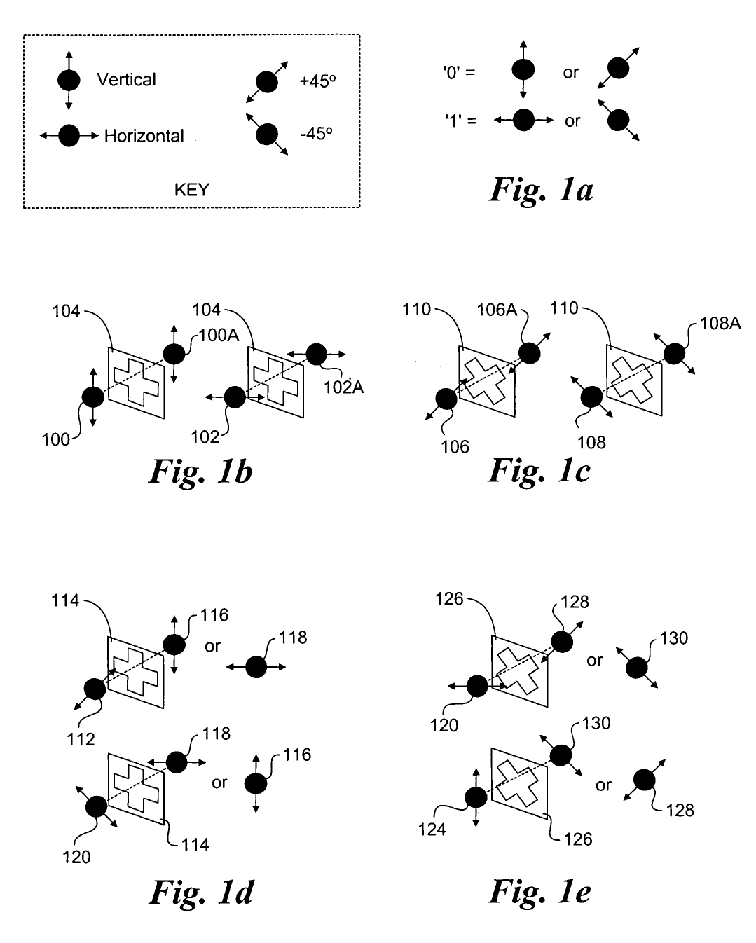

These negative characteristics may be advantageously employed for QC purposes. For instance, the first negative rule states that every measurement perturbs the system. More precisely, this is true except if the quantum state is compatible with the measurement. Various aspects of this phenomena are illustrated in FIGS. 1a-e and discussed below.

Classical information is encoded in digital (binary) format in electrical and optical systems. In contrast, QC systems employ a quantum bit (qubit), which is unique in that it encodes both zero and one information states into a single coherent superposition state. Creation of photonic qubits is possible using several techniques, all of which are mathematically equivalent. For example, qubits can be formed using photon polarization, in the time-domain, and they can be formed spatially. For clarity, the following QC principles are described within the context of photon polarization. An actual system may implement time-domain or spatially-formed qubits to produce similar results.

Well-known techniques may be employed to polarize individual photons, which then may be sent via an optical transport means, such as via optical fiber or through the atmosphere, from a sender to a receiver. The polarization of a photon is the oscillation direction of its electric field. Also referred to as the “spin” direction, the conventional directions for the polarization of a photon are defined as: vertical, horizontal, or diagonal (+45° and −45°). The use of appropriate polarization techniques enables individual photons to be polarized with a selected spin direction. This supports an encoding scheme, wherein the individual quanta are referred to as qubits. FIG. 1a illustrates one exemplary encoding scheme, wherein photons having vertical and +45° polarization represent an encoded value of ‘0’, while photons having horizontal and −45° polarization represent an encoded value of ‘1’. For convenience, this encoding scheme will be used throughout the following examples.

A filter may be used to distinguish between rectilinear (i.e., horizontal and vertical) photons, while another filter may be used to distinguish between diagonal photons. When a photon passes through the correct filter, its polarization does not change. For example, as shown in FIG. 1b, vertical and horizontal photons 100 and 102 pass through a rectilinear filter 104 unperturbed (i.e. the polarization or spin direction is unaltered), as depicted by vertical and horizontal photons 100A and 102A. Similarly, FIG. 1c shows +45° and −45° photons 106 and 108 passing through a diagonal filter 104 unperturbed, as depicted by +45° and −45° photons 106A and 108A.

In contrast, when a photon passes through an incorrect filter, it polarization is modified randomly. Examples of this phenomena are shown in FIGS. 1d and 1e. For instance, as shown in FIG. 1d, when a +45° photon 112 passes through a rectilinear filter 114, the polarization of the photon is randomly changed to one of a vertical photon 116 or a horizontal photon 118. Similar results occur when a −45° photon 112 passes through diagonal filter 114. As shown in FIG. 1e, when a horizontal photon 122 or vertical photon 124 pass through a diagonal filter 126, either a +45° photon 128 or −45° photon 130 will be randomly produced. This randomness, based on the Heisenburg uncertainty, may be employed by QC schemes to facilitate secure key exchanges and identify the existence of an eavesdropper, as follows.

Using conventional sender-receiver terminology, suppose that “Alice” codes information in individual photons, which are then sent to “Bob.” If Bob receives the photons unperturbed, then by the basic axiom (1), the photons were not measured. No measurement implies that an eavesdropper “Eve” did not get any information about the photons, as it is necessary to measure the polarization of each photon in order to derive its encoded value. Thus, after exchanging photons, Alice and Bob can determine whether someone was “listening” (i.e., eavesdropping) by comparing a randomly chosen subset of their data using a public channel. If Bob received the randomly chosen subset unperturbed, then the logic follows that no perturbation exists, indicating no measurements were made along the communication path between Alice and Bob, and thus no eavesdropping occurred.

The first (and pre-eminent) protocol for QC, commonly referred to as the BB84 protocol, was proposed in 1984 by Chares H. Bennett, from IBM New York, and Gilles Brassard, from the University of Montreal. In addition to the BB84 protocol, other QC protocols have been developed, including the 2-state protocol (Charles H. Bennett, 1992), the 6-state protocol (Bruss 1998, Bechmann-Pasquinucci and Gisin 1999), and the EPR protocol (Aurur Ekert, 1991), which is connected to the famous EPR (Einstein, Podolski and Rosen, 1935) paradox. For illustrative purposes, the embodiments discussed herein employ the BB84 protocol. However, other QC protocols known to those skilled in the art may also be implemented.

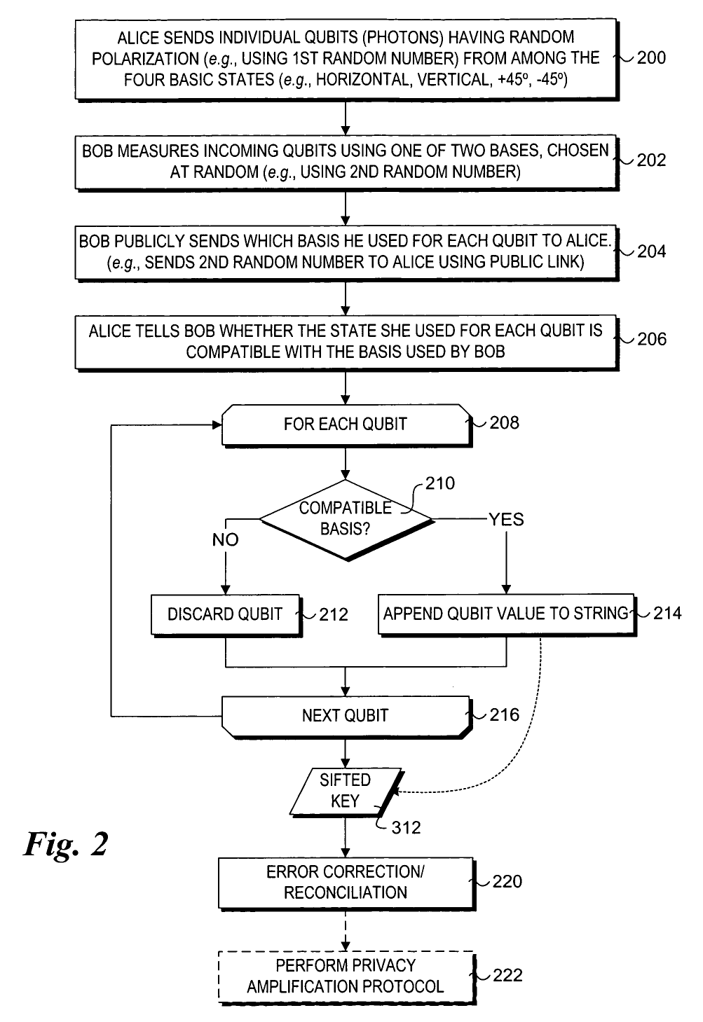

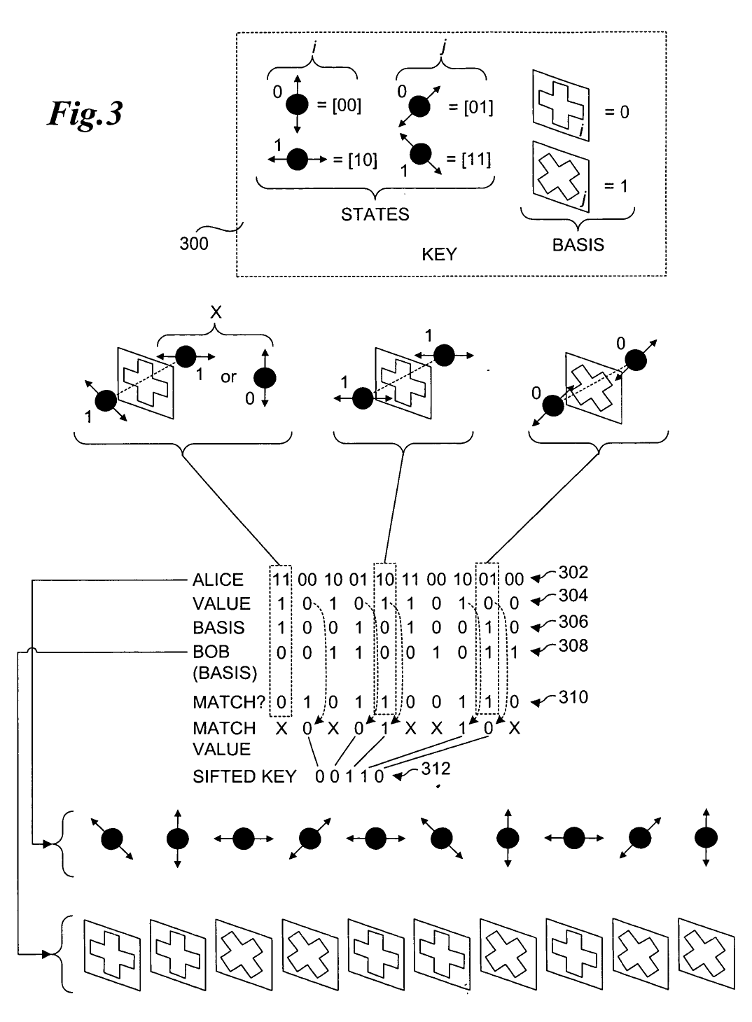

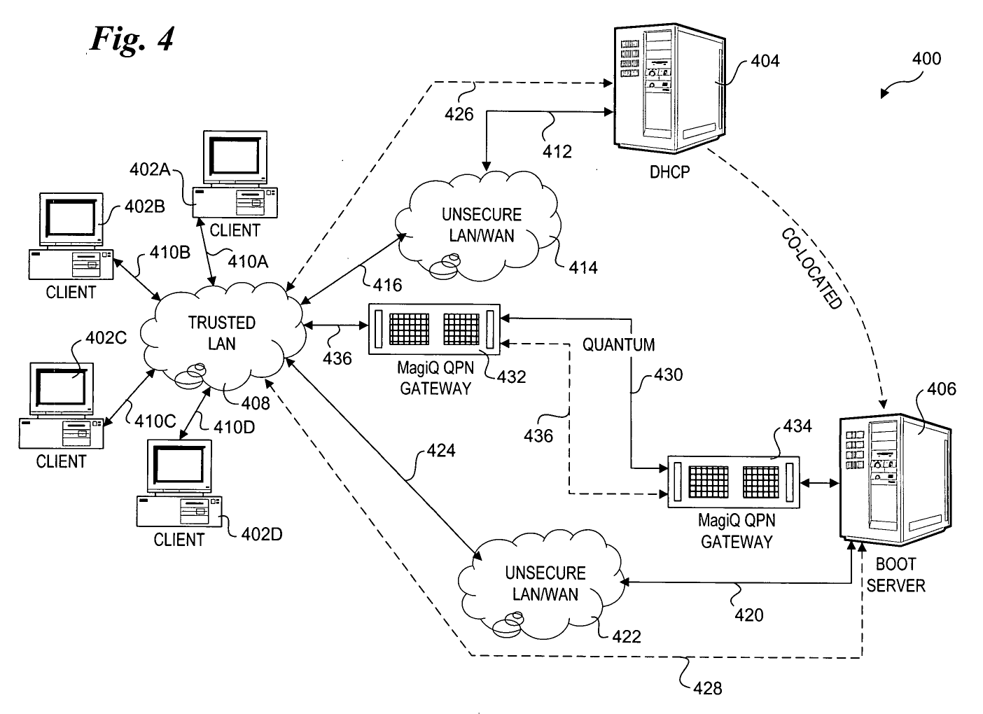

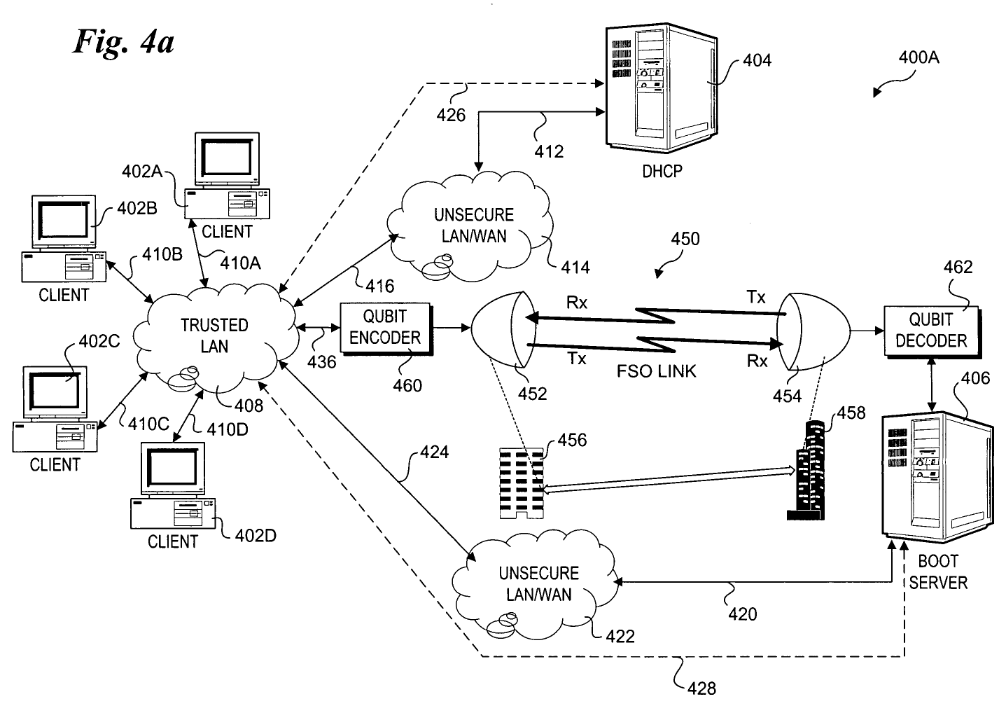

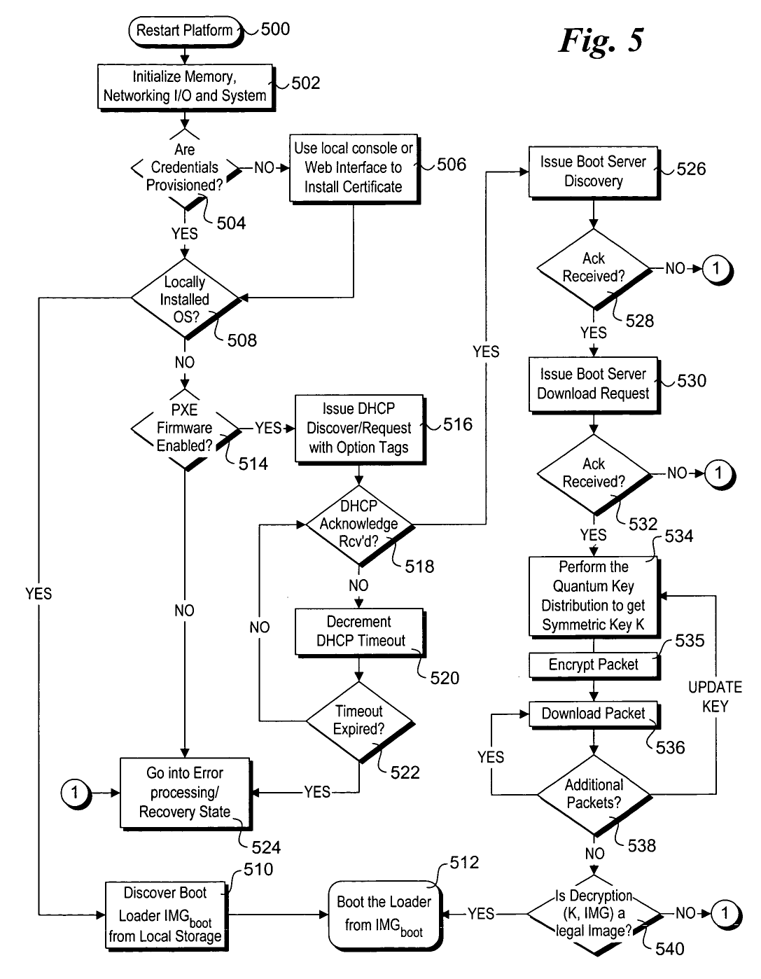

With reference to the flowchart of FIG. 2 and the schematic diagram of FIG. 3, one embodiment of the BB84 protocol is implemented in the following manner. First, in a block 200, Alice sends individual spins (photons) having random polarization from among four basic states. In the illustrated embodiments, these states include the aforementioned horizontal, vertical, +45°, and −45° states. In general, these random selection of qubits based on these four states may be performed using one of several techniques. For instance, a random number bitstream may be generated, wherein pairwise bits are employed, such as depicted by key 300 in FIG. 4. The first bit of each bit pair (e.g., the most significant bit) represents the value of the qubit, while the second bit (e.g., the least significant bit) represents the “basis” used to generate the photonic polarization. In the example of FIG. 3, the bitstream bit pairs are [11], [00], [10], [01], [10], [11], [00], [10], [01], and [00], as shown by a bitstream 302.

In another embodiment, two random number bitstreams and are generated by Alice. The first random number bitstream is used to define the qubit values, while the second random number bitstream is used to define the basis. Under this scheme, each state is determined by combining a qubit value defined by the first bitstream with a corresponding basis defined by the second bitstream on a bitwise ordering. Under conventional terminology, a rectilinear basis (that is, a basis for which a rectilinear polarization filter will enable photons encoded with the rectilinear basis to pass through unperturbed) is defined as the “i” basis, while the diagonal basis is defined as the “j” basis. Examples of the two bitstreams are depicted as an Alice's value bitstream 304 and an Alice's basis bitstream 306.

Returning to the flowchart of FIG. 2, in a block 202 Bob measures the polarization of each incoming photons using one of two basis, selected at random. For example, Bob can generate a second random number to generate an <i, j> basis bitstream, wherein 0 represents the i basis, and 1 represents the j basis. An example of a corresponding bitstream 308 is shown in FIG. 3. As a corollary operation, Bob “publicly” sends which basis he used for each qubit (e.g., the corresponding random number he used) to Alice using a public communication link, as depicted in a block 204. (This operation can also be performed using a private link—the emphasis here is that this information may be revealed to the public without any loss of security).

In response to the basis data received from Bob, Alice returns information to Bob, in a block 206, identifying whether the state she used for each qubit is compatible with the basis used by Bob to measure that qubit. This information is schematically depicted in FIG. 3 as a match bitstream 310. At this point in time, each of Alice and Bob hold the qubit value bitstream and the match bitstream (e.g., bitstreams 304 and 310).

As depicted by start and end loop blocks 208 and 216, the operations corresponding to a decision block 210 and blocks 212 and 214 (as applicable) are then performed for each qubit. A determination is made by decision block 210 to whether a compatible basis was used by Alice and Bob for the currently-evaluated qubit. In accordance with the foregoing technique, this can be done by simply comparing the ordered bit values in Alice's basis bitstream 306 and Bob's basis bitstream 308. If a match exists, the qubit value is appended to a sifted key bitstream, as depicted in block 214. If a match does not exist, the qubit is discarded in block 212. In either case, the logic loops back to start block 208 to begin evaluation of the next qubit. At the conclusion of these operations, a bitstream corresponding to sifted key 312 is produced. The sifted key is also referred to as the “raw” key.

Typically, based on random numbers containing approximately the same number of 1's and 0's, about half of the time the random basis' used by Alice and Bob will match. Thus, the sifted key will be approximately one-half as long as the original number of qubits sent from Alice.

Ideally, the sifted key will not contain any errors. However, practical systems will generally produce some type of errors due to physical limitations in the system components (e.g., imperfect photon generators, fiber, and/or photon detectors). As a result, error correction and reconciliation are performed in a block 220. In general, any of several well-known error-correction algorithms may be employed for this purpose, such as parity-based correction schemes.

Now let's consider security aspects of the foregoing protocol. First, consider some adversary Eve has access to the optical link between Alice and Bob, enabling Eve to intercept qubit transmission from Alice to Bob. Ideally (from Eve's point of view), Eve would like to receive the qubits from Alice, and then send a “cloned” copy of the qubits to Bob, thus avoiding detection. However, proofs have been derived (e.g., Wooters and Zurek, 1982), Milonni and Hardies, 1982, Dieks, 1982) to prove that perfect copying is impossible under quantum physics. Consequently, Eve can't keep a perfect quantum copy, since a perfect quantum copy machine can't exist.

To understand this more clearly, consider how Eve might intercept a stream of qubits. As discussed above, a measurement of each gubit must be performed in order for Eve (or Bob, for that matter) to extract data encoded in the qubit, As a result, the measurement may perturb the qubit, changing its state, depending on if the basis' used by Alice (random) and Eve (also randomly selected) match for a given qubit. Statistically, Eve will get the correct basis about 50% of the time. A non-matching basis will change the state of the qubit polarization (and thus value) in an unpredictable manner. As a result, a corresponding qubit received by Bob will have a different polarization than it originally had when sent by Alice, and have a 50% chance of having its qubit value changed. This will typically produce an error in the sifted key of about 25%. By comparing expected and received qubit values in the sifted keys (via the aforementioned scheme), Bob and Alice can easily determine whether anyone is eavesdropping on the quantum channel. For example, under one commonly used scheme, Alice and Bob verify the integrity of the quantum channel by revealing a random subset of the key bits and checking the error rate using the public communication channel. The presence of an eavesdropper is easily detectable due to an increase in the error rate of generally at least 25%.

Although the QC techniques allows the detection of an eavesdropper, there are some instances under which it will be desired to generate a quantum key even though an eavesdropper is present. In this instance, the eavesdropper will intercept some of the key data, but will generally not have enough information to generate or recover the symmetric quantum key. In order to reduce or eliminate this possibility, an optional privacy amplification protocol may be performed in a block 222 of the FIG. 2 flowchart. In one embodiment, the privacy amplification protocol may be performed in conjunction with the error correction and reconciliation operations of block 220.

In general, the sifted key 312 represents a raw key comprising a bit-string W. Eve may obtain a bit-stream Z, which is partially correlated to W. Privacy amplification is used to get a smaller set of bits, S, whose correlation with Z is below a certain threshold. Typically, a universal hashing function is employed for producing the smaller set of bits, S. For example, a universal hashing function G maps an n-bit string A to an m-bit string B such that, given a1, a2 in A, the probability that g(a1)=g(a2) is at most I/IBI. S is then computed as S=G(W). In addition to this exemplary technique, other similar techniques may be employed.

Until recently, most of the work with regard to QC and its corollary key distribution mechanism QKD has been theoretical and experimental. Although theoretically unbreakable, a QC system must function in a physical world to be of any intrinsic value. Real optical systems are imperfect, introducing unwanted errors and other problems. For instance, the polarization of a photon may be caused to change as a result of passing through a long length of optical fiber due to impurities and other imperfections in the fiber, as well as associated physical phenomena. As discussed above, qubits cannot be copied without detection, thus limiting quantum links to end-point-to-end-point connections (in comparison to conventional network connections that may employ one or more different paths to facilitate a communications link between two end points). Furthermore, it has been shown that optical amplification causes a change in the qubits, thus optical amplification along an end-point-to-end-point connection cannot be employed. However, it is noted that under some types of encoding, quantum repeaters may be employed to lengthen the overall distance between the communicating parties.

Further problems relate to the generation and detection of qubits. To implement a practical QC system, there needs to be a very reliable photon source, that is a source that can generate photons having desired characteristics (e.g. value and basis). Currently, practical implementations rely on faint laser pulses or entangled photon pairs, where both the photon as well as the photon-pair number distribution obeys Poisson statistics. Hence, both possibilities suffer from a small probability of generating more than one photon or photon pair at the same time. The qubits must be transported via a “quantum channel.” Currently, the approaches used are categorized by two classifications: optical fiber and free-space links (i.e., through the atmosphere). Each technique has its advantageous and disadvantageous.

For example, single mode fibers are used to transport optical signals in many of today's high-speed networks. These optical fibers may also be used to transport qubits. However, photon traversal of a singlemode fiber may produce changes in polarization due to polarization effects. These generally include Birefringence, Polarization Mode Dispersion (PMD), and Polarization Dependent Losses (PDL). In addition to polarization effects, chromatic dispersion (CD) can cause problems for quantum cryptography as well.

Transmission over free space (also known as free-space optical (FSO) links) features some advantages compared to the use of optical fibers. The atmosphere has a high transmission window at a wavelength of around 770 nm where photons can easily be detected using commercially-available, high efficiency photon counting modules. Furthermore, the atmosphere is only weakly dispersive and essentially non-birefringent at these wavelengths. It will thus not alter the polarization state of a photon.

However, there are some drawbacks concerning FSO links as well. In contrast to transmitting a signal in a guiding medium where the energy is “protected” and remains localized in a small region in space, the energy transmitted via a free-space link spreads out, leading to higher and varying transmission losses. In addition to loss of energy, ambient daylight, or even light from the moon at night, might couple into the receiver, leading to a higher error rate. However, the latter errors can be maintained at a reasonable level by using a combination of spectral filtering (˜1 nm interference filters), spatial filtering at the receiver and timing discrimination using a coincidence window of typically a few ns. Finally, it is clear that the performance of free-space systems depends dramatically on atmospheric conditions and may be substantially degraded in the absence of clear weather.

Another consideration relates to operations required at the receiving end, and concerns single-photon detection. In principle, this can be achieved using a variety of techniques, for instance photo-multipliers, avalanche-photodiodes, multi-channel plates, and super-conducting Josephson junctions. Today, the best choice is avalanche-photodiodes (APD). Generally, three different types of semiconductor materials are used: either Silicon, Germanium, or Indium Gallium Arsenide, depending on the wavelength employed for the quantum channel. However, current APD technology has not been targeted toward detection of individual photons, but rather targeted for other purposes. It is envisioned that as QC and QKD technologies mature, APD's, as well as other single photon detection technologies, will be developed for QC and QKD purposes.

Recently, the first commercially-available QKD product has been introduced. This product, called MagiQ QPN™ security gateway 5505, was developed by MagiQ Technologies, Inc., New York, N.Y. and Somerville Mass. The MagiQ QPN™ security gateway 5505 is a rack-mountable chassis unit that includes built-in functionality to support the BB-84 protocol, as well as several conventional security protocols, including VPN (virtual private network) and AES (Advanced Encryption Standard) data encryption.

Secure Network Boot Process Using Symmetric Quantum Keys

In accordance with further aspects of embodiments of the invention, a secure network boot and configuration scheme is now discussed that leverages the aforementioned QC and QKD technology. In one embodiment, the scheme employs a quantum key distribution process during a system pre-boot to facilitate authentication and loading of a boot image.

As an overview of one embodiment of this process, attention is directed to the network architecture 400 diagram of FIG. 4. This diagram shows a network infrastructure including conventional network communication links, as well as quantum channel link. In general, the conventional network communication links may be facilitated by conventional networking components, such as switches, routers, bridges, etc., connected via wired (e.g., twisted-pair copper, co-axial copper or optical fiber) and/or wireless links. For simplicity, the various network infrastructure is depicted in the conventional manner using network clouds.

In the illustrated configuration, various clients 402A, 402B, 402C, and 402D, are linked in communication with a DHCP (Dynamic Host Control Protocol) server 404 and a boot server 406. In the illustrated configuration, clients 402A-D are communicatively-coupled to a trusted local area network (LAN) 408 via respective secure links 410A-D. In turn, DHCP server 404 is connected to trusted LAN 408 via a link 412 coupled to an unsecure LAN/WAN (wide area network) 414, and via a link 416 coupled between unsecure LAN/WAN 414 and trusted LAN 408. Similarly, Boot server 404 is connected to trusted LAN 408 via a link 420 coupled to an unsecure LAN/WAN 422, and via a link 424 coupled between unsecure LAN/WAN 422 and trusted LAN 408. As illustrated by the dash lines used to represent optional links 426 and 428, DHCP server 404 may be directly linked to trusted LAN 408 via link 426, while boot server 406 may be directly linked to trusted LAN 408 via link 428. In another embodiment, boot server 406 supports a co-located DHCP server, such that the functionality discussed below for DHCP server 404 and boot server 406 are supported by a single computer server located at boot server 406.

For illustrative purposes, trusted LAN 408 is representative of a local area network that employs secure links. Typically, such links are facilitated via some type of encryption process. However, in other embodiments, trusted LAN 408 may not employ linked secured via encryption, but is rather referred to as secure due to access restrictions. For example, trusted LAN 408 may represent a LAN in a small office.

In contrast, unsecure LAN/WAN 414 and 422 are labeled “unsecure” because they may or may not employ secure links, depending on the implementation. The general concept being illustrated is that an eavesdropper may “tap” into one or more of links 412, 416, 420, and 424, as well as other portions of unsecure LAN/WAN 414 and 422 to intercept data using well-known eavesdropping techniques. It is also possible that unsecure LAN/WAN 414 and 422 may employ secure links.

System architecture 400 also includes a quantum channel supported via an optical link 430 coupled between a pair of MagiQ QPN gateway 432 and 434. As illustrated in FIG. 4, MagiQ QPN gateway 432 is linked to trusted LAN 408 via a link 436, while MagiQ QPN gateway 434 is linked to boot server 406 via a trusted link 438. As an option, MagiQ QPN gateway 434 and boot server 406 may be connected via a trusted network (not shown). Furthermore, MagiQ QPN chassis 432 and 434 may be configured to support a secure optical communication link 436, such that optional link 428 may be facilitated by the combination of links 426, 430, 438 and MagiQ QPN gateways 432 and 434.

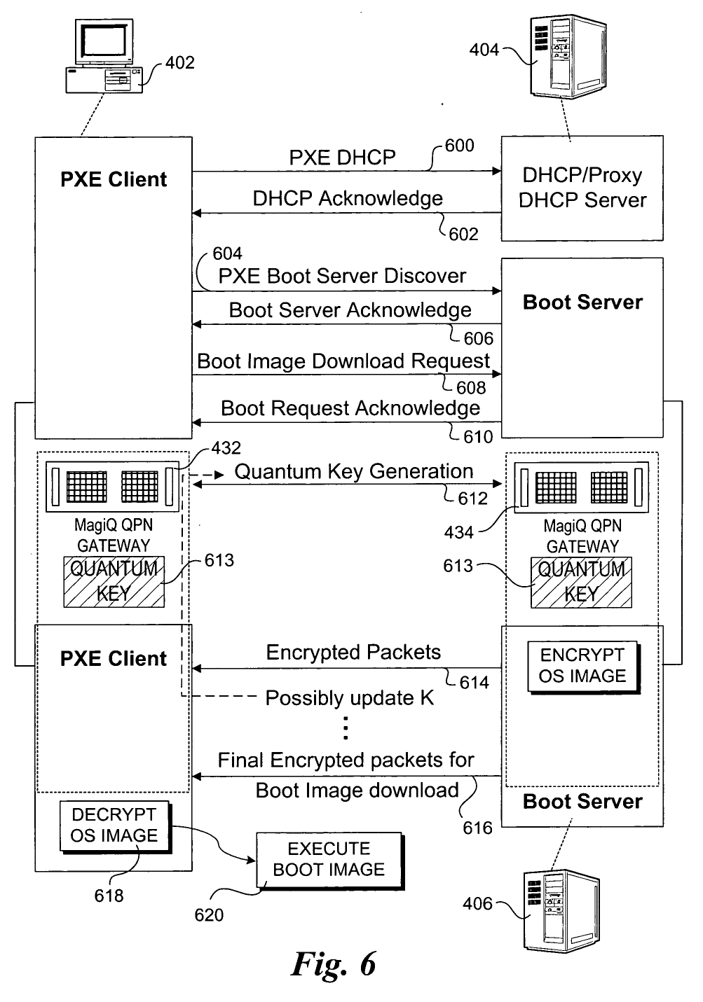

With reference to the flowchart of FIG. 5 and the message exchange diagram of FIG. 6, one embodiment of a secure network boot process employing QKD proceeds as follows. The process begins with a platform restart in a start block 500. For example, this may be a power-on event (cold) boot, or in response to a system reset (warm boot). In response, pre-boot operations are performed to initialize the platform, including memory, input/output (I/O) and system initialization, as depicted in a block 502.

In accordance with one embodiment, the initialization operations of block 502 and subsequent pre-boot operations are carried out by firmware components that are compliant with an extensible firmware framework known as the Extensible Firmware Interface (EFI) (specifications and examples of which may be found at http://developer.intel.com/technology/efi). EFI is a public industry specification that describes an abstract programmatic interface between platform firmware and shrink-wrap operation systems or other custom application environments. The EFI framework include provisions for extending BIOS functionality beyond that provided by the BIOS code stored in a platform's BIOS device (e.g., flash memory). More particularly, EFI enables firmware, in the form of firmware modules and drivers, to be loaded from a variety of different resources, including primary and secondary flash devices, option ROMs, various persistent storage devices (e.g., hard disks, CD ROMs, etc.), and even over computer networks.

Continuing with the flowchart, at a decision block 504 a determination is made to whether credentials are provisioned for the platform. In one embodiment, the credentials are embodied in a digital certificate that is either signed by a certificate authority (CA) or self-signed. Such digital certificates are used to authenticate clients and servers using well-known authentication techniques. If credentials are not provisioned, a local console or Web interface is employed in a block 506 to install an appropriate certificate.

In response to either a YES determination from decision block 504 or the completion of the operation of block 506, the logic proceeds to a decision block 508, wherein a determination is made to whether a locally-installed operating system (OS) exists. For instance, a check is made to whether a bootable OS image exists on a local (to the client platform) hard disk or CD-ROM drive. If a local bootable OS image exists, the boot loader for the image is discovered in a block 510, and the discovered loader is booted in a block 512 in the conventional manner used to boot an operating system image.

If a locally-installed OS image is not present, the logic proceeds to a decision block 514, wherein a determination is made to whether firmware configured in accordance with the Pre-Execution Environment (PXE) standard is enabled. PXE firmware is employed for performing firmware-based operations during the pre-boot that would typically be performed by an operating system during OS runtime. In short, PXE firmware supports various OS runtime functionality during the pre-boot phase, including network communications. PXE is defined on a foundation of industry-standard Internet protocols and services that are widely deployed in the industry, namely TCP/IP (Transmission Control Protocol/Internet Protocol), DHCP, and TFTP (Trivial File Transfer Protocol). These standardize the form of the interactions between clients and servers. To ensure that the meaning of the client-server interaction is standardized as well, certain vendor option fields in the DHCP protocol may be used, which are allowed by the DHCP standard. The operations of standard DHCP and/or BOOTP servers (that serve up IP addresses and/or network bootstrap programs) will not be disrupted by the use of the extended protocol. Clients and servers that are aware of these extensions will recognize and use this information, and those that do not recognize the extensions will ignore them.

If PXE firmware is enabled, the next set of operations involves an exchange of messages between client 402 and DHCP server 404 to obtain an IP address using the PXE protocol. For simplicity, this message exchange is depicted as a PXE DHCP request 600 and a DHCP acknowledge message 602 in FIG. 6. In practice, the series of communications exchanges comprises the following:
1. The client broadcasts a DHCP_Discover message on its local sub-net searching for DHCP server; the request may go over sub-net boundaries if the switches are set up to relay the requests. In accordance with FIG. 4, the local sub-net is trusted LAN 408 and the sub-net boundary extends across unsecure LAN/WAN 414 (or unsecure LAN/WAN 422 if the DHCP server functions are co-located at boot server 406).
2. A listening DHCP server (e.g., DHCP server 404) sends a DHCP_Offer message containing an offered IP address to the client;
3. The client accepts the offered IP address and broadcasts a DHCP_Request message on the local sub-net containing the accepted IP address; and
4. The DHCP server responds via a unicast to the client with a DHCP_Ack message to acknowledge the IP address has been accepted.

The foregoing illustrates a sequence under which a single DHCP server receives the DHCP_Discover message. Under some circumstances, multiple DHCP servers may receive the DHCP_Discover message, and offer respective IP addresses in response. Under this circumstance, the client will select one of the offered IP addresses. The net result is that the client board will end up with an IP address. The particular address is not important, and will generally relate to the IP address scope allotted to the DHCP server by an administrator. At this point, client board 402 can communicate with other network entities via unicasts rather than broadcasts.

Further details of the client-side operations corresponding to the foregoing set of DHCP message exchanges are shown in blocks 516, 518, 520, and 522 of FIG. 5. In response to a DHCP request (e.g., PXE DHCP request message 600), a determination is made in a decision block 518 to whether or not a DHCP acknowledge message (e.g., DHCP acknowledge message 602) is received. In one embodiment, a timeout mechanism is used to advance processing operation in view of an unavailable or non-cooperative DHCP server. Accordingly, a DHCP timeout value is decremented in a block 520 and a timeout expiration check is made in a decision block 522. If the timeout period expires, the logic proceeds to a block 524, wherein appropriate error processing and/or recovery state operations are performed.

The remaining message exchanges shown in FIG. 6 are between the client 402 and the boot server 406 (or a co-located DHCP/boot server). In general, a boot server is used to provide bootable operating system (OS) images to network clients, thus removing the requirement of the client needing to store a local OS image and applications on local hard disk drives or system non-volatile memory. Even if images and applications are stored locally in flash memory or on a local disk drive, the same technique may be used to update the OS and image. In addition to this function, boot server 406 may also be configured to serve the function of a network address proxy. That is, the boot server is configured to allocate network address in lieu of a conventional address allocated, such as a DHCP server or a domain controller.

In order to exchange messages with boot server 406, client 402 needs to know the boot server's network address, and a transmission protocol needs to be established. In one embodiment, if the DHCP and PXE servers reside on the same machine, the response to the DHCP request above will contain information needed by the client to start a TFTP (Trivial File Transfer Protocol) session. TFTP is a simplified transmission protocol that does not require the overhead of more robust protocols, such as the TCP/IP protocol used for most network traffic. If the DHCP and boot servers are hosted by separate machines (necessitating separate network addresses) and DHCP server 404 is configured to know the IP address of boot server 406, the boot server's address may be included in the DHCP message exchange. Client 402 may then contact boot server 406 via the boot server address to obtain information for starting a TFTP session. If the DHCP server does not have address information for the PXE server, the client may broadcast a PXE boot server discover message 604 akin to the DHCP discover message discussed above to locate the PXE server, as shown in a block 526 of FIG. 5. Upon receiving the PXE discover message, the PXE server will respond with information for starting a TFTP session, including its network address, as depicted by a boot server acknowledgement message 606. If the boot server acknowledgement message is not received, the logic proceeds to block 524 for error processing and/or recovery, as depicted by a decision block 528.

As discussed above, the DHCP message exchange results in an IP address issued to client 402. Once the client has an IP address, as evidence by a YES to decision block 518, the logic proceeds to a block 526, wherein the client issues a PXE boot server discover message 604. This message is broadcast over the network searching for PXE boot servers. In response to the message, boot server 406 returns a boot server acknowledge message 606. In cases in which the address of the boot server was not provided via the PXE DHCP message exchange, the boot server acknowledgement message contains a network address for the boot server. If an acknowledge message is not received, the logic proceeds to perform appropriate error processing/recovery state operations in block 524, as depicted by a decision block 528.

If an acknowledge message is received, the PXE client issues a boot image download request message 608 to the boot server in accordance with a block 530. If accepted, the boot server returns a boot request acknowledge message 610 to the PXE client. As depicted by a decision block 532, if this acknowledge message is not received by the PXE client, the logic proceeds to block 524 to perform appropriate error processing/recovery state operations.

Next, in accordance with a block 534 and the Quantum Key Generation messages 612, the quantum key distribution process of FIG. 2 is performed to obtain a symmetric quantum key 613. In one embodiment, the quantum key distribution process is transparently handled by MagiQ QPN gateway units 432 and 434 using built-in functionality. That is, the combination of these units facilitates a secure link 436 using built-in quantum key distribution functions, wherein the link is secured via encoding data transported across the link using the corresponding symmetric quantum keys that are generated. In another embodiment, the symmetric quantum keys are accessible to each of PXE client 402 and boot server 406 and the secure channel is facilitated by firmware running on PXE client 402 and software running on boot server 402 that implements the symmetric quantum key for encryption/decryption of data sent a link or network path coupled between PXE client 402 and boot server 406.

In one embodiment, the boot image (e.g., bootable operating system image) is downloaded using TFTP. TFPT is a lightweight protocol that transfers data over a network link using one or more packets. As depicted by blocks 535, 536, and 538 of FIG. 5 and encrypted packets 614 and final encrypted packets 616 in FIG. 6, an operating system boot image is downloaded over the secure link by means of multiple TFTP packets containing data that are encrypted at the boot server (or at the MagiQ QPN gateway unit 434) with the symmetric quantum key and decrypted at the PXE client (or at the MagiQ QPN gateway unit 432) using the its copy of the symmetric quantum key. During this process, the symmetric quantum key may be updated zero or more times. The end result is a decrypted copy of the bootable OS image 618 residing on PXE client 402.

As depicted by a decision block 540, in one embodiment a determination is made to whether the decrypted image is a legal image. For example, various authentication schemes may be employed to verify whether the downloaded boot image is from a legitimate boot server, such as using digital certificates or other security measures that are well-known in the art. If the image is determined to be legal, the loader portion of the image is booted in block 512 to boot the image, which can then be executed in accordance with a block 620.

As discussed above, a quantum channel may be facilitated by an optical link, including free-space optical links. A system architecture 400A that implements an FSO link is shown in FIG. 4a. In general, system architectures 400 and 400A employ similar components (e.g., those sharing identical reference numbers), except the quantum is facilitated by an FSO link 450.

In further detail, the FSO link 450 employs a pair of FSO transceivers 452 and 454, which are located at opposing ends of the FSO link, such as at respective buildings 456 and 458. Currently, FSO transceivers to facilitate FSO links are available from several companies, including Terabeam Corporation, Redmond, Wash. Each of FSO transceivers 452 and 454 is able to transmit a transmitted (Tx) signal that is received at the opposing FSO transceiver as a received (Rx) signal. A qubit encoder 460 that is included as part of an FSO transceiver 452 is used to encode photons that are sent out via a signal transmitted by FSO transceiver 452. At the signal receive end, a qubit decoder 462 is employed to decode the encoded photons using techniques known to those skilled in the art.

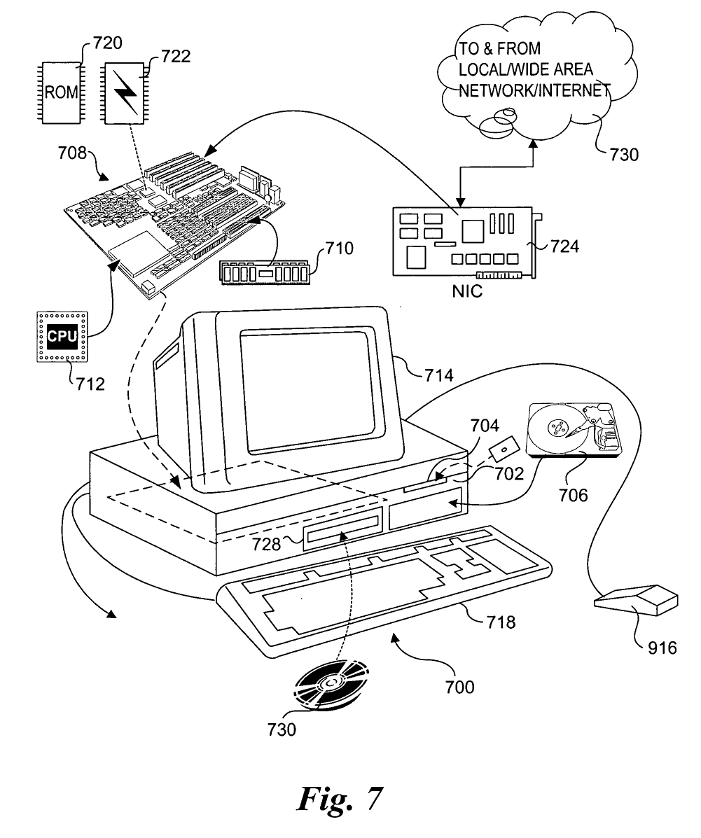

FIG. 7 illustrates an embodiment of an exemplary computer system 700 to practice embodiments of the invention described above. Computer system 700 is generally illustrative of various types of computer devices, including personal computers, laptop computers, workstations, servers, etc. For simplicity, only the basic components of the computer system are discussed herein. Computer system 700 includes a chassis 702 in which various components are housed, including a floppy disk drive 704, a hard disk 706, a power supply (not shown), and a motherboard 708. Hard disk 706 may comprise a single unit, or multiple units, and may optionally reside outside of computer system 700. The motherboard 708 includes memory 710 coupled to one or more processors 712. Memory 710 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like. Processor 712 may be a conventional microprocessor including, but not limited to, a CISC (complex instruction set computer) processor, such as an Intel Corporation x86, Pentium, or Itanium family microprocessor, a Motorola family microprocessor, or a RISC (reduced instruction set computer) processor, such as a SUN SPARC processor or the like.

The computer system 700 also includes one or more non-volatile memory devices on which firmware is stored. Such non-volatile memory devices include a ROM device 720 or a flash device 722. Other non-volatile memory devices include, but are not limited to, an Erasable Programmable Read Only Memory (EPROM), an Electronically Erasable Programmable Read Only Memory (EEPROM), or the like. The computer system 700 may include other firmware devices as well (not shown).

A monitor 714 is included for displaying graphics and text generated by firmware, software programs and program modules that are run by computer system 700, such as system information presented during system boot. A mouse 716 (or other pointing device) may be connected to a serial port, USB (Universal Serial Bus) port, or other like bus port communicatively coupled to processor 712. A keyboard 718 is communicatively coupled to motherboard 708 in a similar manner as mouse 716 for user entry of text and commands. In one embodiment, computer system 700 also includes a network interface card (NIC) 724 or built-in NIC interface (not shown) for connecting computer system 700 to a computer network 730, such as a local area network (LAN), wide area network (WAN), or the Internet. In one embodiment, network 730 is further coupled to a remote computer (not shown), such that computer system 700 and the remote computer can communicate. In one embodiment, a portion of the computer system's firmware is loaded during system pre-boot from the remote computer.

Computer system 700 may also optionally include a compact disk-read only memory (“CD-ROM”) drive 728 into which a CD-ROM disk 730 may be inserted so that executable files, such as an operating system, and data on the disk can be read or transferred into memory 710 and/or hard disk 706. Other mass memory storage devices may be included in computer system 700.

In another embodiment, computer system 700 is a handheld or palmtop computer, which are sometimes referred to as Personal Digital Assistants (PDAs). Handheld computers may not include a hard disk or other mass storage, and the executable programs are loaded from a corded or wireless network connection into memory 710 for execution by processor 712. A typical computer system 700 will usually include at least a processor 712, memory 710, and a bus (not shown) coupling the memory 710 to the processor 712.

It will be appreciated that in one embodiment, computer system 700 is controlled by operating system software that includes a file management system, such as a disk operating system, which is part of the operating system software. For example, one embodiment of the present invention utilizes Microsoft Windows® as the operating system for computer system 700. In another embodiment, other operating systems such as, but not limited to, an Apple Macintosh® operating system, a Linux-based operating system, the Microsoft Windows CE® operating system, a Unix-based operating system, the 3Com Palm® operating system, or the like may also be use in accordance with the teachings of the present invention.

As discussed above, the operations performed by a PXE client during the pre-boot phase are facilitated via execution of firmware code that may be stored locally to the client or downloaded from a network store during the pre-boot under provisions defined by the EFI standard. In one embodiment, the firmware code is configured as multiple modules and interfaces that facilitate communication between the modules.

Thus, embodiments of this invention may be used as or to support a firmware and software code executed upon some form of processing core (such as processor 712) or otherwise implemented or realized upon or within a machine-readable medium. A machine-readable medium includes any mechanism that provides (i.e., stores and/or transmits) information in a form readable by a machine (e.g., a computer, network device, personal digital assistant, manufacturing tool, any device with a set of one or more processors, etc.). In addition to recordable media, such as disk-based media, a machine-readable medium may include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
generating a symmetric quantum key using an optical link communicatively-coupled at opposing ends to a client computer and a boot server, respectively;
employing the symmetric key to establish a secure communication channel between the client computer and boot server;
downloading an operating system image from the boot server to the client computer via the secure communication channel; and
booting the operating system image to boot the client computer.

2. The method of claim 1, wherein the optical link comprises a free-space optical link.

3. The method of claim 1, wherein the symmetric quantum key is generated using a quantum cryptography key exchange mechanism based on the BB84 protocol.

4. The method of claim 1, further comprising:
employing the optical link for the secure communication channel.

5. The method of claim 1, further comprising:
establishing a communication link between the client computer and the boot server that is separate from the optical link; and
implementing the communication link as the secure communication link by encoding data sent over the communication link using the symmetric key.

6. The method of claim 1, further comprising:
updating the symmetric quantum key while the boot image is being downloading over the secure communication channel;
employing respective symmetric quantum keys that are updated to encode respective portions of the boot image at the boot server as those symmetric keys are active; and
employing the respective symmetric quantum keys to decode respective portions of the boot image that are received at the client computer.

7. The method of claim 1, further comprising:
verifying whether an eavesdropper is present during generation of the symmetric quantum key.

8. The method of claim 7, wherein it is verified that an eavesdropper is present during generation of the symmetric quantum key, the method further comprising:
employing a privacy amplification protocol based on information corresponding to the symmetric quantum key at each of the client computer system and boot server to recalculate the symmetric quantum key.

9. The method of claim 1, further comprising:
employing the trivial file transfer protocol (TFTP) over the secure communication channel to download the operating system image.

10. The method of claim 1, further comprising:
determining a network location for the boot server.

11. The method of claim 10, wherein the network location for the boot server is determined by performing operations including:
performing a dynamic host control protocol (DHCP) message exchange between the client computer and a DHCP server to obtain an internet protocol (IP) address;
broadcasting a boot server discover message over a network to which the boot server is connected; and
returning a boot server acknowledgement message from the boot server to the client computer identifying an IP address for the boot server.

12. The method of claim 10, wherein the network location for the boot server is determined by performing operations including:
performing a pre-execution environment (PXE) dynamic host control protocol (DHCP) message exchange between the client computer and a DHCP server; and
providing a network address of the boot server in a PXE DHCP acknowledgement message returned from the DHCP server to the client computer.

13. A method, comprising:
performing a pre-execution environment (PXE) dynamic host control protocol (DHCP) message exchange between one of a DHCP server or a DHCP proxy and a PXE client computer;
issuing a boot image download request from the PXE client computer to a PXE boot server communicatively-coupled to the PXE client computer via a network link;
generating a symmetric quantum key using an optical link communicatively-coupled at opposing ends to the PXE client computer and the PXE boot server, respectively;
employing the symmetric key over the network link to establish a secure communication channel between the PXE client computer and the PXE boot server;
downloading an operating system image from the PXE boot server to the PXE client computer via the secure communication channel; and
booting the operating system image to boot the PXE client computer.

14. The method of claim 13, further comprising:
broadcasting a PXE boot server discover message over a computer network to which the PXE client computer and the PXE boot server are communicatively-coupled; and
sending a boot server acknowledge message from the PXE boot server to the PXE client computer in response to the PXE boot server discover message.

15. The method of claim 13, further comprising:
verifying whether an eavesdropper is present during generation of the symmetric quantum key.

16. The method of claim 15, wherein it is verified that an eavesdropper is present during generation of the symmetric quantum key, the method further comprising:
employing a privacy amplification protocol based on information corresponding to a sifted key at each of the PXE client computer system and the PXE boot server to recalculate the symmetric quantum key.

17. The method of claim 13, further comprising:
employing the trivial file transfer protocol (TFTP) over the secure communication channel to download the operating system image.

18. The method of claim 13, further comprising:
communicatively coupling the PXE client to a first quantum channel gateway and communicatively coupling the PXE boot server to a second quantum channel gateway, the first and second quantum channel gateway coupled to one another via the optical link and configured to automatically support a quantum channel; and
employing the quantum channel to download the operating system boot image.

19. A machine-readable medium to provide instructions, which if executed on a pre-execution environment (PXE) client computer perform operations including:
performing client-side processing corresponding to a PXE dynamic host control protocol (DHCP) message exchange between one of a DHCP server or a DHCP proxy and the PXE client computer;
issuing a boot image download request to a PXE boot server communicatively-coupled to the PXE client computer via a network link;
employing a symmetric quantum key generated via a quantum key distribution mechanism to establish a secure communication channel between the PXE client computer and the PXE boot server;
receiving an encrypted operating system image from the PXE boot server via the secure communication channel;
decrypting the operating system boot image using the symmetric quantum key; and
booting the operating system image to boot the PXE client computer.

20. The machine-readable medium of claim 19, wherein the machine-readable medium comprises a flash chip.

21. The machine-readable medium of claim 19, wherein the instructions comprise a set of firmware modules compliant with the Extensible Firmware Interface (EFI) standard.

22. The machine-readable medium of claim 19, wherein execution of the instructions performs the further operations of:
employing client-side operations to facilitate the trivial file transfer protocol (TFTP) over the secure communication channel to download the encrypted operating system image.

23. The machine-readable medium of claim 19, wherein execution of the instructions performs the further operations of:
receiving a PXE DHCP acknowledge message identifying an network location of the PXE boot server from said one of a DHCP server or a DHCP proxy; and
employing the network address to communicate with the PXE boot server.

24. The machine-readable medium of claim 19, wherein execution of the instructions performs the further operations of:
broadcasting a PXE boot server discover message over a network to which the PXE client is communicatively-coupled; and, in response thereto,
determining if a boot server acknowledge message is received.

25. A computer system, comprising:
a processor;
memory, coupled to the processor;
a network interface, coupled to the processor;
a firmware storage device, coupled to the processor; having firmware instructions stored therein that when executed on the processor cause operations to be performed, including:
performing client-side processing corresponding to a pre-execution environment (PXE) dynamic host control protocol (DHCP) message exchange between one of a DHCP server or a DHCP proxy and the computer system;
issuing a boot image download request to a PXE boot server communicatively-coupled to the PXE client computer via the network interface;
obtaining a symmetric quantum key generated via a quantum key distribution mechanism;
receiving an encrypted operating system image from the PXE boot server from the PXE boot server via the network interface;
decrypting the operating system boot image using the symmetric quantum key; and
booting the operating system image to boot the computer system.

26. The computer system of claim 25, wherein execution of the firmware instructions performs the further operations of:
employing client-side operations to facilitate the trivial file transfer protocol (TFTP) over the secure communication channel to download the encrypted operating system image.

27. The computer system of claim 25, wherein execution of the firmware instructions performs the further operations of:
receiving a PXE DHCP acknowledge message identifying a network location of the PXE boot server from said one of a DHCP server or a DHCP proxy; and
employing the network address to communicate with the PXE boot server.

28. The computer system of claim 25, wherein the firmware storage device comprises a flash memory device.
